(19) United States
(12) Patent Application Publication
(10) Pub. No.: US 2014/0062723 A1
(43) Pub. Date: Mar. 6, 2014

(54) TELEMETRY DEVICE

(71) Applicant: Claas Agrosystems KGAA MBH & Co. KG, Guetersloh (DE)

(72) Inventors: André Kluge, Guetersloh (DE); Fabian Kruszona, Bielefeld (DE)

(73) Assignee: CLAAS AGROSYSTEMS KGAA MBH & CO., KG, Guetersloh (DE)

(21) Appl. No.: 13/970,798

(22) Filed: Aug. 20, 2013

(30) Foreign Application Priority Data
Sep. 4, 2012 (DE) 10 2012 017 451.9

(51) Int. Cl. G08C 17/02

(52) U.S. Cl. CPC G08C 17/02
USPC 340/870.07

(57) ABSTRACT

A telemetry device for state acquisition for an agricultural working train (with at least a drive machine and an attachment) has a transmission unit for receiving state values from the working train, a tele-unit for wireless transmission of teledata sets to a telemetry server and a processing unit for generating the teledata sets on the basis of the state values that are received. The received state values embody drive state values assigned to the drive machine and device state values assigned to the attachment. The processing unit groups the received drive state values with the received device state values based on predefined grouping instructions and the grouped state values to generate a teledata set according to generation instructions.

The invention described and claimed hereinbelow also is described in German Patent Application DE 10 2012 017451.9, filed on Sep. 4, 2012. The German Patent Application, subject matter of which is incorporated herein by reference, provides the basis for a claim of priority of invention under 35 U.S.C. 119(a)-(d).

### BACKGROUND OF THF INVENTION

The invention relates to a telemetry a telemetry device for state acquisition for an agricultural working train comprising a drive machine and an attachment, where the telemetry device has a transmission unit for receiving state values from the working train, a tele-unit for the preferably wireless transmission of teledata sets to a telemetry server and a processing unit for generating the teledata sets on the basis of the received state values.

In modern agriculture, it is becoming increasingly important to utilize production resources in a highly efficient manner. This relates to the agricultural ground itself, in which the processes of cultivation, fertilization, and harvesting, for instance, must be adapted precisely to the conditions and the history of the particular part of the ground, and to the agricultural machines, which are intended for use to process an agricultural area in a short period of time and without idling, and in such a way that the need to perform unnecessary maintenance work is prevented. Finally, in terms of business administration, it should be possible to maximize the transparency of yield, economic efficiency, and cost.

These objectives can be achieved, in particular, by capturing data related to the agricultural working processes in the most comprehensive and seamless manner possible, and by bundling and evaluating these data in a centralized manner. With respect to collecting and transmitting these data, the prior art, such as DE 101 20 173 A1, makes known telemetry devices that are used for state acquisition. In the present case, the term “state acquisition” refers very generally to the determination and provision of state values that describe the state of a working train or a part of the working train. Such a working train usually comprises a tractor having a separate drive, and at least one attachment, which is drawn by such a tractor and is controlled by the tractor or by a control device mounted on the tractor.

The known telemetry device is mounted on an attachment, which is drawn by a drive machine, and receives measurement data from sensors, which are also mounted on the attachment. These measurement data are then transmitted via a wireless connection to a central telemetry server.

The above-described combination of drive machines and attachments is often implemented or changed dynamically, and thereby may differ with each operation and during an operation. A disadvantage of the known telemetry device is that every attachment transmits its own measurement data to the central telemetry server independently of the measurement data of the further agricultural machines provided in the same working train.

In a situation described above, it is very difficult to obtain findings that result from the simultaneous, in particular, examination of measurement data from several machines of a working train. In order to accomplish this, the measurement data obtained from various machines must be assigned to one another en the basis of more or plausible and, therefore, unreliable assumptions. For example, it is difficult to subsequently synchronize, with respect to time, the measurement data obtained from various machines. Not all the results obtained from an evaluation method based on such assumptions are usable.

### SUMMARY OF THE INVENTION

The present invention overcomes the shortcomings of known arts, such as those mentioned above.

To that end, the invention provides a telemetry device for state acquisition for an agricultural working train wherein the state values that have been acquired and transmitted to a telemetry server can be better evaluated.

It is essential to group the independently determined state values of the agricultural machines of a working train, including the drive machine, before transmission to the telemetry server and, on the basis of the grouped data, to generate a teledata set for transmission to the telemetry server.

The grouping of state values having different origins is based on the premise that examining the state values of different origins in entirety usually provides a broader depiction of the overall state of the working train than would be possible based on state values related to individual components. For example, it is possible for a certain event, such as a plow becoming jammed, to be reflected in the state values of the drive machine and in the state values of the attachment, which is the plow in this case. By grouping the data from the drive machine with the data from the attachments and converting the grouped data into a teledata set to be transmitted, the information content of the acquired state values is increased without the need to perform additional physical measurements.

According to the invention, the received state values are grouped very generally with respect to the time-based relationship thereof, very particularly with respect to the simultaneous occurrence thereof or proximity with respect to time. Also, every teledata set is based at least approximately on an instantaneous snapshot of all state values. Preferably, the data transmitted to the telemetry server are updated regularly.

Different machines can comprise highly diverse tools, sensors and other equipment features and, are therefore also capable of providing highly diverse data. These equipment features can also change over time if additional attachments or set-ups are provided. In order to achieve long-term flexibility in the interaction of the various working machines, the invention provides that dynamic definition files be used, which specify, characterize, and otherwise comprehensively describe the data interface to an attachment and, in particular, the measurement data provided by the attachment. It is thereby possible to flexibly respond when an additional measurement instrument is installed on an attachment, for instance.

The agricultural machines that are used are usually series-production products. The invention makes it possible to monitor every single machine throughout the entire service life thereof and distinguish these machines from identical products of the same series in that a unique vehicle identifier is used, also by the telemetry server itself.

In order to ensure seamless monitoring by the telemetry server, it is important that additional measurement data on relevant measured events be present that are assigned to these events. Accordingly, the invention provides a mechanism for ensuring that a complete teledata set for such events is transmitted.

The invention also provides advantages in terms of the subsequent equipping of a drive machine having a telemetry device according to the invention.

### BRIEF DESCRIPTION OF THE DRAWINGS

Further features and advantages of the invention will become apparent from the description of embodiments that follows, with reference to the attached figures, wherein:

FIG. 1 presents a schematic depiction of a working train that has a drive machine, on which a telemetry device according to the invention is disposed, and that has two attachments;

FIG. 2 depicts a block diagram of a telemetry device according to the invention; and

FIG. 3 depicts a block diagram of the communication between a telemetry device according to the invention and two attachments.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

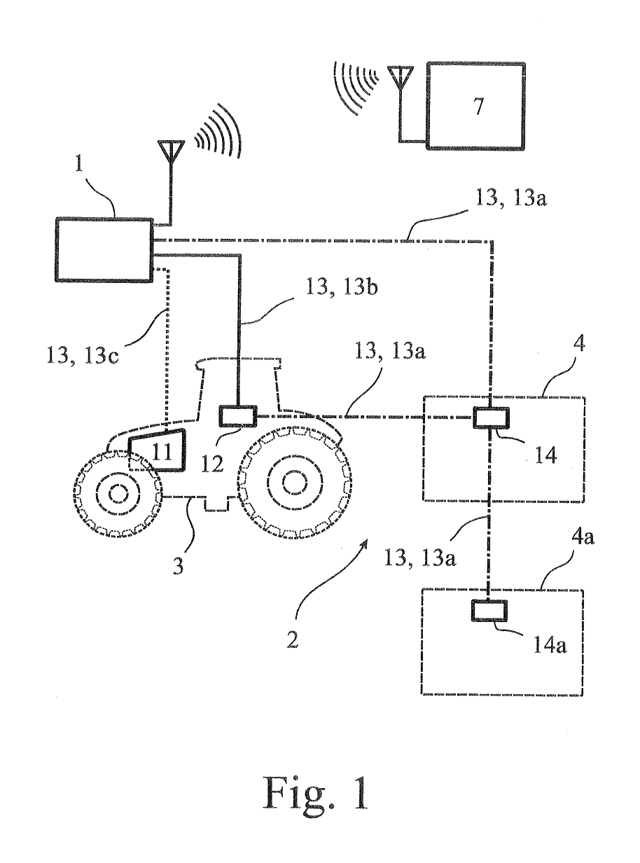

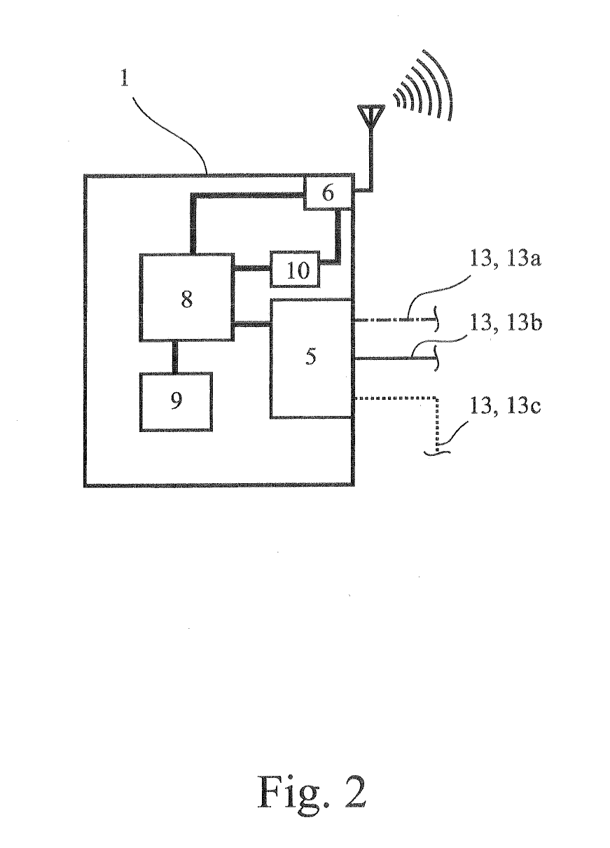

The telemetry device 1 according to the invention is depicted in FIGS. 1 and 2, and is used to acquire state values from an agricultural working train 2 (see FIG. 1). State values in this sense are any measured or calculated actual or setpoint values, in particular, measured physical quantities, geographical positions, switching states, running counters, etc., as well as non-physical data such as names, serial numbers, and version numbers. The term “state value” refers to the value itself, such as a number, and not to the variable or the attribute that represents the meaning of the state value.

The working train (as seen in FIG. 1) comprises a drive machine 3 having a separate drive, an attachment 4 and a further attachment, which is referred to as the second device 4a. The attachment 4 and the second device 4a are drawn by the drive machine 3. Further attachments can be provided in addition to the second device 4a.

According to the invention, the telemetry device 1 comprises a transmission unit 5 for receiving state values from the working train 2. The state values are usually received using a communication protocol.

The telemetry device 1 further comprises a tele-unit 6 for transmitting teledata sets to a telemetry server 7, wherein the telemetry server 7 is operated in a central location. This transmission is preferably wireless. Basically, however, the telemetry server 7 also can be located on the drive machine 3.

The telemetry device 1 further comprises a processing unit 8 for generating the teledata sets on the basis of the state values that are received. The processing unit 8 can be any type of computing device for a digital data processing. In particular, it is possible for software programs, including an operating system, to run on the processing unit 8. The teledata sets need not be created exclusively on the basis of the state values that are received; in fact, further data, variables, or instructions can be incorporated into this procedure.

According to the invention, the state values that are received comprise drive state values and device state values. Drive state values are state values transmitted by the drive machine 3, which are measured or determined by or at the drive machine 3 and are assigned thereto. Similarly, device state values are state values from an attachment, especially state values that are transmitted to the attachment 4 and are measured or determined at the attachment 4. Further types of state values are also possible.

The transmission unit 5 receives the state values from the drive machine 3, as well as from the attachment 4 and the second device 4a. The state values also can reach the transmission unit 5 via a different physical channel depending on the origin, whether it is the drive machine 3, the attachment 4 or the second device 4a.

Furthermore, the processing unit 8 is designed to group the drive state values that are received with the device state values that are received, on the basis of grouping instructions. Grouping in this manner means defining a group to which these drive state values and device state values are logically assigned, and, therefore, are assigned to one another. This grouping can be implemented in any manner. Further types of state values can be grouped into this group and, more than one drive state value and more than one device state value can be included in the group. The only requirement is that the group includes at least one drive state value and at least one device state value.

Furthermore, the processing unit 8 generates a teledata set on the basis of the grouped state values in accordance with generation instructions. Since (as stated), the grouped state values include at least one drive state value that is received and at least one device state value, these are therefore also used to generate at least one drive state value and at least one device state value of the teledata set. The generation instructions can include any type of computational processing or any other type of processing, and is preferably predefined. If the group comprises further state values, these further state values also can be used according to the generation instructions as the basis for generating the teledata set.

Preferably, one state variable is assigned to each device state value and, in particular, to each state value. While a state value (or a device state value) is a numerical value, e.g., of a measured variable or the value of a serial number, the term “state variable” in this case means the physical variable or the logical meaning of the device state value or the state value to which this state variable is assigned. In other words, the device state values or state values are the pure numbers and, the state variables indicate the significance of the device state values or state values to which they are assigned. The same state variable can be assigned to a plurality of device state values, in particular, a plurality of state values, for instance, in the event that a plurality of physical measurements is performed on the same measuring device at different times. Alternatively or additionally, a state variable can be assigned to each drive state value.

In an embodiment, the telemetry device 1 comprises a memory unit 9 for storing the most recently received, device state value, preferably the most recently received state value, of each state variable. Furthermore, the grouping instructions call for grouping the multitude of the most recently received device state values, preferably the multitude of the most recently received state values, for each state variable with one another. Therefore, when the teledata set is generated, a group of the most recent device state values, preferably the most recent state values, is formed for each state variable. As a result, device state values (preferably state values) that are received are automatically grouped with one another at the same time or separated by a short time interval. Since the focus is on receipt in the telemetry device, synchronization differences between internal clocks of the drive machine 3 and the attachments 4 do not create problems. Alternatively or additionally, the memory unit can also be designed to store the drive state values in a similar manner.

Seamless reproduction of the information available on the drive machine 3 on the telemetry server 7 is achieved by transmitting all the information that is received by the telemetry device 1 and is considered relevant to the telemetry server 7 in the raw form thereof. This is made possible in that the generation instructions call for including the grouped state values into the teledata set. The grouped state values are therefore incorporated into the teledata set at least partially and preferably in entirety.

The state values preferably comprise the measured values that are measured at a working device and/or on an area to be worked. A working device in this sense can be any type of device at the drive machine 3 or the attachment 4, such as a servomotor. A measured value can be, for example, a measured torque, a measured current, or a measured rotational frequency. An area to be worked is the terrain surface, including objects or vegetation located thereon, on which the drive machine 3, the attachment 4, or the second device 4a moves. In this case, a measured value could be a measured chlorophyll content or a measured ground level.

In order to periodically update the data on the telemetry server 7, the processing unit 8 is preferably designed to trigger the generation of a teledata set and the storage thereof in a telememory 10 at a specified minimum frequency. Storage in a telememory 10 is a preliminary step for transmission to the telemetry server 7.

The flexibility of composing a working train is increased, in particular, in that the telemetry device does not require advance knowledge of the type, number, and equipment of the attachment 4 in particular. This can be achieved in that the attachment 4 does not transmit the related information to the telemetry device 1 until this telemetry device is started. Therefore, the processing unit 8 is preferably designed to receive a device definition and, in fact, preferably after the start-up procedure and before receipt of a state value. It also is preferable for the tele-unit 6 to be designed to transmit this device definition to the telemetry server 7. In this manner the telemetry server 7 can also dynamically adapt to a reconfiguration.

The device definition can be, for example, a data sequence formatted according to the Extensible Markup Language (XML) that comprehensively describes the communication parameters of the drive machine 3 or the particular attachment 4 and, in particular, characterizes the transmitted state values extensively and according to a fixed scheme in terms of the internal distribution, length, meaning, relation to physical units, etc.

Therefore, the device definition preferably assigns to each device state value the particular state variable thereof. This information also can be encoded in the data sequence formatted according to XML. Moreover, the device definition can indicate which of the received data can be considered state values and, especially, device state values upon generation of the teledata set.

Within the context of the ISO bus according to ISO 11783, such a device definition also is referred to as a device description object or a machine description file. According to ISO 11783, this device description object contains a definition, via the DeviceProcessDataProperty field of the DeviceProcessData of each object, wherein the object corresponds to a state value as to whether the corresponding state value belongs to the default measured values and is therefore automatically recorded by the attachment 4. The state values for which this is the case can then be considered the state values to be processed, within the meaning of the invention.

In order to ensure seamless monitoring of an attachment 4 for a long period of time, it is important for teledata sets or the corresponding parts thereof received by the telemetry server 7 to be unambiguously assignable to a certain attachment 4, even if this attachment is replaced, dynamically during an operation (for example, by another attachment potentially having the same design). To this end, the device definition includes a unique vehicle identifier. This unique vehicle identifier can be in the form of a serial number similar to the vehicle identification number known from the automotive industry, which also unambiguously assigns a manufacturer to the vehicle identifier. This unique vehicle identifier preferably also is included in the generated teledata set.

In order to provide an instantaneous snapshot of all state values at the instant when a certain state changes, the device definition characterize a state variable as a triggering variable, wherein the processing unit 8 triggers the generation of a teledata set and stores the teledata set in the telememory 10 upon receipt of a state value, the assigned state variable of which is characterized as a triggering variable. Therefore, the teledata set is generated, and then transmitted, as soon as a state value that was defined as a triggering variable changes.

A state variable can be characterized as the triggering variable in that the device definition describes that the corresponding state values are transmitted by the attachment 4 in the event that a state value changes. In a machine description file according to ISO 11783, the determination of a state variable as a triggering variable corresponds to assigning the value “on change” (meaning “when a change occurs”) in the DataLogMethod field of the DataLogTrigger of the corresponding object.

Advantageously, in addition, a minimum time interval can be defined (e.g., also via the device definition), within which the triggering of a new generation of a teledata set is blocked even if the related state value changes again, the state variable of which is characterized as a triggering variable.

The solution according to the invention also can be applied, preferably, for the case in which the working train 2 comprises a plurality of attachments (see FIG. 1). In this case, the working train 2 comprises the second device 4a as the further attachment, wherein the state values received by the transmission unit 5 also comprise second-device state values and the processing unit 8 is designed to include a received second-device state value in the grouping (in accordance with the grouping instructions).

Second device state values are therefore values that were transmitted by the second device 4a and were measured or determined at the second device 4a, or values that are assigned to the second device 4a. Given that at least one second-device state value also is included in the grouping, a teledata set is also generated on the basis of the second-device state value.

If the telemetry device 1 is intended to be retrofitted on a drive machine 3, this drive machine 3, as shown in FIG. 1, usually already comprises a drive device 11 as well as drive electronics 12, which control the drive machine 3 itself and the attachment 4 and a second device 4a (which is present in this case), and communicates therewith. In this case, the transmission unit 5 preferably receives state values from a plurality of physical channels 13. It is advantageous in particular when the transmission unit 5 is designed to receive drive state values from a plurality of physical channels 13.

Proceeding therefrom, the plurality of physical channels 13 preferably comprises an ISO bus 13a. The ISO bus 13a corresponds to the ISO 11783 standard and is connected to the drive electronics 12 of the drive machine 3, to device electronics 14 of the attachment 4, and to second-device electronics 14a of the second device 4a.

The telemetry device 1 preferably also comprises a control device bus 13b, which is connected to the drive electronics 12, and a motor bus 13c, which is connected to the drive device 11. The control device bus 13b uses a manufacturer-specific protocol based on CAN (Controller Area Network), and the motor bus 13c uses the J1939 protocol. In this manner, the telemetry device 1 can use the previously defined and implemented interface to the device electronics 14 according to ISO 11783, but can simultaneously and directly access the state values that can be obtained from the drive machine 2. The telemetry device 1 is therefore capable of receiving drive state values via the ISO bus 13a, and via the control device bus 13b and the motor bus 13c.

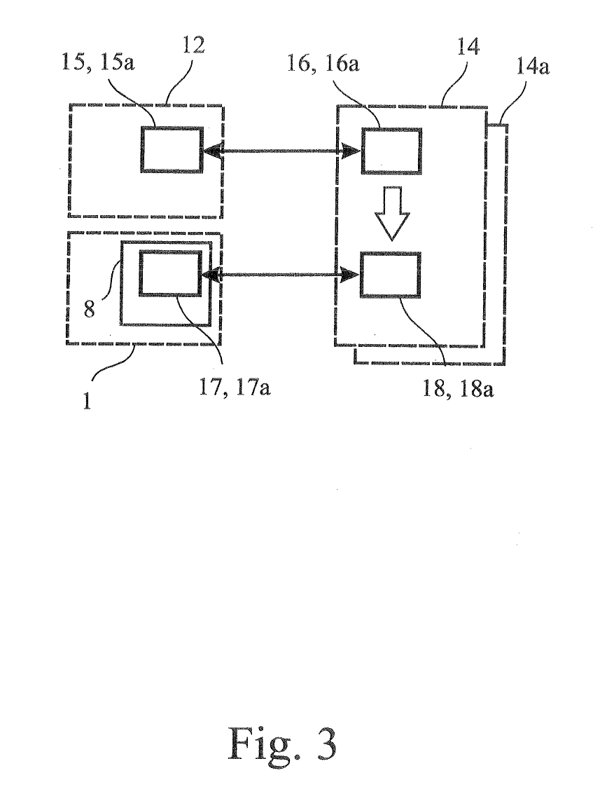

FIG. 3 shows one embodiment of the communication between the processing unit 8 and the drive electronics 12, which are disposed on the drive machine 3, and the device electronics 14 disposed on the attachment 4, in accordance with the FIG. 1 arrangement. The device electronics 14 are the central control and monitoring unit for the attachment 4.

In order to monitor the attachment 4 by means of the device electronics 14, a control thread 15 runs on the drive electronics 12, which implements a task controller 15a in the sense of Part 10 of the ISO 11783 standard. The task controller is designed to operate a corresponding device control structure 16, which forms a virtual interface at the level of the software and forms a working set 16a within the meaning of Part 10 of the ISO 11783 standard (which is also referred to as the task control client) on the device electronics 14 in accordance with the ISO 11783 standard, and to thereby control the attachment 4. Such operation takes place via data exchange and, in general, can involve connection-oriented data transmission or packet-oriented data transmission.

A logging thread 17 runs on the telemetry device 1 and on the processing unit 8, wherein the logging thread communicates with a corresponding logging structure 18, which also forms a virtual interface at the level of the software, on the device electronics 14, also in accordance with the ISO 11783 standard. This communication also can be either packet-oriented or connection-oriented. The logging thread 17 does not form a task controller, but rather a data logger 17a as a command class expansion within the meaning of the ISO 11783 standard (i.e., a command class that is not prespecified in the ISO 11783 standard), but lies within the scope of an expansion that is permitted according to the standard.

In order to prevent the need for the logging thread 17 to operate the working set 16a, i.e., the “so-called” task control client, the logging structure 18 forms a data logger client 18a, which similarly corresponds to the command class of the data logger 17a.

After a restart or initialization, the logging structure 18 first transmits a device definition (which is a device description object according to ISO 11783), to the logging thread 17 and then regularly and autonomously transmits to the logging thread 17 the state values that must be recorded by default according to the device definition. The device definition is preferably identical to the device definition transmitted by the device control structure 16 to the control thread 15 according to ISO 11783. Alternatively, the device definition deviates from the device definition that is transmitted by the device control structure 16 to the control thread 15. The device control structure 16 and the logging structure 18 also have access to the same data on the device electronics 14.

Therefore, the device electronics 14 according to the invention for an agricultural attachment 4 comprising a device control structure 16, which forms a logical interface, preferably a working set 16a, for actuation of the device electronics 14, communicates with the transmission unit 5 of a telemetry device 1 according to the invention. The device electronics 14 have a logging structure 18, which forms a separate logical interface for the preferably autonomous transmission of device state values from the attachment 4 to the transmission unit 5.

The advantage of such a distribution between the device control structure 16 and the logging structure 18 is that this logging function does not require intervention in the interaction between the task controller 15a and the task control client or working set 16a. A telemetry device 1 can be easily added to an existing system in which communication takes place in this manner between the drive electronics 12 and the device electronics 14, wherein the telemetry device does not access the existing communication for logging purposes, yet still utilizes the fundamental mechanisms thereof.

A logical interface within the meaning of the invention is a software interface or a virtual interface. In order to provide a separate interface of this type, for the device control structure 16 and the logging structure 18 may be separate interfaces at the software level. If there were a separate physical layer located underneath, the logical interfaces would necessarily differ.

Given that the drive electronics 12 and the telemetry device 1 are separate devices in the present case, which is not a necessary requirement, however, the control thread 15 and the logging thread 17 also van be separate.

Furthermore, an agricultural working train according to the invention comprises a drive machine 3 and an attachment 4, and a telemetry device 1. The attachment 4 preferably comprises device electronics 14 for communication with the transmission unit 5. These device electronics are designed to autonomously transmit device state values to the transmission unit 5, wherein transmission of this type having a specified minimum frequency is particularly preferred.

In order to permit the above-described dynamic reconfiguration of the working train 2, it is further preferred that the device electronics 14 are designed to transmit, after a start-up procedure and before transmission of a state value, especially a device state value, an initialization message to the transmission unit 5, wherein the initialization message preferably includes a device definition.

As previously described (FIG. 1), the working train also comprises a second attachment, namely a second device 4a having second-device electronics 14a. The second-device electronics 14a form a central control and monitoring unit for the second device 4a in the same sense as the device electronics 14 for the attachment 4. The second-device electronics 14a are also connected to the ISO bus 13a. Similarly to the device electronics 14, the second-device electronics 14a also offer virtual interfaces in the form of a device control structure and a logging structure, each of which has similar functionality. These interfaces of the second-device electronics 14a communicate independently of the device electronics 14 with the corresponding counterparts, namely the control thread 15 and the logging thread 17. Therefore, they are the same as for the device electronics.

The device definition of the second device 4a can be identical to the device definition of the attachment 4, with the exception of the unique vehicle identifier, for example, when the attachment 4 and the second device 4a have the same design. Alternatively, when the second device 4a is a device that differs from the attachment 4, the particular device definition also differs. Otherwise, the statements relating to the device electronics 14 presented in this regard apply similarly to the second-device electronics 14a. The working train can comprise further attachments in the same manner.

The method according to the invention for state acquisition for an agricultural working train, which comprises a drive machine 3 and an attachment 4, involves receiving state values, generating teledata sets, and transmitting the teledata sets to a telemetry server, characterized in that the received state values comprise drive state values and device state values. The method also involves grouping the received drive state values with the received device state values according to grouping instructions, wherein the teledata set is generated on the basis of the grouped state values according to generation instructions.

The computer program according to the invention comprises program code or program code means comprising computer readable instructions for implementing all the method steps of the method according to the invention when the computer program's program code means or computer readable instructions are run in or executed by a computer. The program code means or computer readable instructions are stored in or on a computer readable medium, which is preferably non-transitory.

Further preferred embodiments of the device electronics according to the invention, the agricultural working train according to the invention, the method according to the invention, and the computer program according to the invention, arise from the preferred embodiments of the telemetry device according to the invention.

What is claimed is:

1. A telemetry device (1) for state acquisition for an agricultural working train (2) that comprises a drive machine (3) and an attachment (4), the telemetry device (1) comprising:
a transmission unit (5) for receiving state values from the working train (2);
a tele-unit (6) for wireless transmission of teledata sets to a telemetry server (7); and
a processing unit (8) for generating the teledata sets on the basis of the received state values;
wherein the received state values comprise drive state values assigned to the drive machine (3) and device state values assigned to the attachment (4);
wherein the processing unit (11) groups the received drive state values with the received device state values on the basis of predefined grouping instructions; and, on the basis of the grouped state values, generated a teledata set according to generation instructions.

2. The telemetry device (1) according to claim 1, wherein the grouping instructions call for grouping the state values with one another that are related to one another in a predetermined manner based on time.

3. The telemetry device (1) according to claim 1, wherein a state variable is assigned to every device state value, wherein the telemetry device (1) comprises a memory unit (9) for storing the most recently received device state value, of each state variable, and wherein the grouping instructions call for grouping the multitude of the most recently received device state values for each state variable with one another.

4. The telemetry device (1) according to claim 1, wherein the state values comprise measured values that were measured at a working device, an area to be worked or both.

5. The telemetry device (1) according to claim 1, wherein the processing unit (8) triggers the generation of a teledata set and the storage thereof in a telememory (10) at a specified minimum frequency.

6. The telemetry device (1) according to claim 1, wherein the processing unit (1) receives a device definition after a start-up procedure and before receipt of a state value and wherein the device definition assigns a particular state variable to each device state value.

7. The telemetry device according to claim 6, wherein the device definition comprises a unique vehicle identifier.

8. The telemetry device (1) according to claim 6, wherein the device definition characterizes a state variable as a triggering variable, and wherein the processing unit (8) triggers the generation of a teledata set and stores the teledata set in the telememory (10) upon receipt of a state value, the assigned state variable of which is characterized as a triggering variable.

9. The telemetry device (1) according to claim 1, wherein the working train (2) comprises a second device (11) as the further attachment, wherein the received state values also include second-device state values, and wherein the processing unit (8) includes a received second-device state value in the grouping, in accordance with the grouping instructions.

10. The telemetry device (1) according to claim 1, wherein the transmission unit (5) receives state values from a plurality of physical channels (13) in order to receive drive state values from a plurality of physical channels (13).

11. The telemetry device (1) according to claim 10, wherein the plurality of physical channels (13) comprises an ISO bus (13a), a control device bus (13b) connected to the control electronics 12 and a motor bus (13c) connected to the motor, the drive train or both.

12. Device electronics (14) for an agricultural attachment (4) having a device control structure (16), which forms a logical interface and, a working set (16a) for actuation of the device electronics (14),
wherein the device electronics (14) communicate with a transmission unit (5) of a telemetry device (1) according to claim 1, and comprises a logging structure (28) that forms a separate logical interface for autonomous transmission of drive state values of the attachment (4) to the transmission unit (5).

13. An agricultural working train (2) comprising a drive machine (3), an attachment (4) and a telemetry device (1) according to claim 1, wherein the attachment (4) has device electronics (14) for communication with the transmission unit (5) that autonomously transmit device state values to the transmission unit (5) at a specified minimum frequency.

14. A method for state acquisition for an agricultural working train comprising a drive machine (3) and an attachment (4), the method comprising the steps of:
receiving state values;
generating teledata sets;
transmitting the teledata sets to a telemetry server;
wherein the received state values comprise drive state values assigned to the drive machine (3) and device state values assigned to the attachment (4); and
grouping the received drive state values with the received device values on the basis of preferably predefined grouping instructions;
wherein the teledata set is generated on the basis of the grouped state values according to generation instructions.

15. A computer program product comprising program code means embedded in a non-transitory computer-readable medium for implementing all the method steps according to claim 14 when the computer program code means is run in a computer.
